(19) United States
(12) Patent Application Publication
(10) Pub. No.: US 2004/0136306 A1
(43) Pub. Date: Jul. 15, 2004

(54) METHOD FOR WRITING DATA ONTO AN OPTICAL STORAGE MEDIA

(76) Inventor: Ming-Yang Chao, Hsin-Chu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,860

(22) Filed: Aug. 22, 2003

(30) Foreign Application Priority Data
Jan. 10, 2003 (TW) 092100570

(51) Int. Cl. G11B 7/0045

(52) U.S. Cl. 369/59.11

(57) ABSTRACT

A method for writing data onto an optical storage medium using an optical storage device. The method includes the following steps: providing an EFM waveform that contains a previous land, a current pit, and a next land to the optical storage device; choosing a set of write strategy parameters from a plurality of sets of write strategy parameters stored in a memory according to lengths of the previous land, the current pit, and the next land; generating a write period waveform according to the chosen set of write strategy parameters; and driving a pickup with the write period waveform, so as to write data onto the optical storage medium.

### BACKGROUND OF INVENTION

1. Field of the Invention

The present invention relates to a method for writing data onto an optical storage medium, and more particularly, to a method for writing data onto an optical storage medium according to an EFM waveform containing a previous land section, a current pit section, and a next land section.

2. Description of the Prior Art

As the calculation capability of computers becomes faster and faster and as network technology development progresses rapidly, using the computer as a multimedia interface and as a platform for internet access is becoming increasingly popular with all types of users. As a result, demand for mass storage devices is rapidly increasing. Devices utilizing optical storage media such as CD-R (Compact Disk-Recordable) are preferred for such kinds of storage as this media type is more inexpensive, compact, and portable than other types with respect to the same storage capacity. As various kinds of optical disk drives and burners appear with faster speed and more reliable operation, and more particularly, as DVD-R (Digital Versatile Disk-Recordable) appear with the same physical size but with many times the storage capacity of CD-R, optical disk drives and burners have practically become standard accessories of the personal computer.

When an optical storage device such as a CD Burner or a DVD Burner writes data to an optical storage medium such as the CD-R or the DVD-R, the data is transformed into a storage format of the optical storage medium using an encoder of the optical storage device. In the prior art, the data format of the optical storage medium is usually the RLL Modulation (Run-Length Limited Modulation). For example, an EFM Waveform (Eight-to-Fourteen Modulation Waveform) encodes the data to be stored in the optical storage medium using a square wave of various waveform lengths (pulse-widths and intervals) along a time axis. For the CD-R, the pulse-widths and the intervals of the square waves are all multiples of an EFM base period, ranging from three times the base period to eleven times the base period, and the optical storage device writes the data to the optical storage medium according to the EFM Waveform. When the data is stored in the optical storage medium, a plurality of land sections and pit sections of various lengths on the optical storage medium are utilized to represent the data, and the lengths of the land sections. The pit sections correspond with the waveform lengths of the EFM Waveform. According to this relationship, the optical storage device can write the data onto the optical storage medium.

In practice, the optical storage device transforms the EFM Waveform into a write time waveform for driving an optical pickup according to a set of write strategy parameters. For a CD-RW (CD-ReWritable), before the optical storage device writes data, the write time waveform is set to an erase power state (to erase previously written signals and reform the land section). When the optical storage device writes data, the write time waveform is set to a bias power state and inserted with a plurality of serial pulses (to form the pit sections), and each pulse switches the write time waveform from the bias power state to a write power state. Meanwhile, the write strategy parameters define the pulse-widths and the intervals under different conditions of the land sections and the pit sections.

In the prior art, the write strategy parameters define the write time waveform according to a 1T strategy. That is, a length of a period of the pulses of the write time waveform is equal to a length of one EFM base period. However, as the burning technology of the optical storage device increases, and more particularly, as more and more optical storage devices with higher writing speeds appear (for example, 32× and 48× writing speed burners), the EFM base period has become shorter and shorter so that the interval (at the bias power state) after each pulse (at the write power state) of the write time waveform is not long enough to allow the chemicals on the surface of the optical storage medium to properly solidify to form the pit section without distortion. In order to solve this problem, the prior art describes a 2T strategy (Orange Book Part III, Volume 3). According to the 2T strategy, the length of the write time waveform pulse period is equal to twice the EFM base period, and therefore, the interval after each pulse is long enough to leave the chemicals on the surface of the optical storage medium properly solidified and form the pit section without distortion.

According to the 2T strategy described in the prior art, the write strategy parameters are determined simply according to the length of the current pit section of the EFM waveform. The current pit section of the EFM waveform corresponds to the current pit section on the surface of the optical storage medium. The influences of the previous land section (prior to the current pit section) and the next land section (after the current pit section) on the current pit section writing result are not considered. In addition, the pulse-widths and intervals of all but the last pulse are constants according to the 2T strategy. Only the parameters relating to the last pulse can be adjusted, hence there is a very limited degree of freedom to adjust the write strategy parameters to adequately eliminate jitters of the current pit sections due to internal inaccuracies of the optical storage medium.

### SUMMARY OF INVENTION

It is therefore a primary objective of the claimed invention to provide a method for writing data onto an optical storage medium according to the information of an EFM waveform containing a previous land section, a current pit section, and a next land section, so as to solve the above-mentioned problem.

Provided according to the claimed invention is a method adapted to an optical storage device for writing data to an optical storage medium. The optical storage device has a memory and a pickup. The memory stores a plurality of sets of write strategy parameters. The method further comprising: providing an EFM Waveform (Eight-to-Fourteen Modulation Waveform) to the optical storage device, the EFM Waveform including a previous land section, a current pit section, and a next land section; choosing a set of write strategy parameters from the plurality of sets of write strategy parameters stored in the memory according to waveform lengths of the previous land section, the current pit section, and the next land section; generating a write time waveform according to the chosen set of write strategy parameters; and driving the pickup with the write time waveform, so as to write data corresponding to the EFM Waveform to the optical storage medium.

According to the claimed invention, the method includes choosing a corresponding set of write strategy parameters according to information of a previous land section, a current pit section, and a next land section of an EFM waveform. When the set of write strategy parameters is chosen, not only the information of the current pit section but also that of the previous land section and the next land section is considered so that a more accurate control over the lengths of the land sections and the pit sections can be achieved. In addition, the method of the present invention defines the write strategy parameters in great detail so that there is higher degree of freedom to adjust the write strategy parameters to adequately eliminate jitters of the current pit sections due to internal inaccuracies of the optical storage medium.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is block diagram of a high-speed optical recording apparatus according to the present invention.

FIG. 2 is a flowchart of a method for writing data onto an optical storage medium according to the present invention.

FIG. 3 is a waveform diagram of write strategy parameters for a 2T strategy according to the present invention.

FIG. 4 is a flowchart of the method of choosing a set of write strategy parameters of Step 12 in FIG. 2.

### DETAILED DESCRIPTION

The present invention provides a method adapted to an optical storage device for writing data to an optical storage medium wherein the optical storage device has a memory and a pickup, and the memory stores a plurality of sets of write strategy parameters. For example, in a first embodiment of the present invention, the optical storage device is a CD Burner (Compact Disk Burner) and the optical storage medium is a CD-RW (CD-ReWritable). In another embodiment, the optical storage device is a DVD Burner (Digital Versatile Disk Burner) and the optical storage medium is a DVD-R (DVD-Recordable) or a DVD-RW (DVD- ReWritable). Although the present invention will be described in the context of an EFM Waveform (Eight-to-Fourteen Modulation Waveform), this is not a limitation. An optical storage utilizing another RLL Modulation Waveform (Run-Length Limited Modulation Waveform), which does not hinder the actualization of the present invention, is also an embodiment of the present invention.

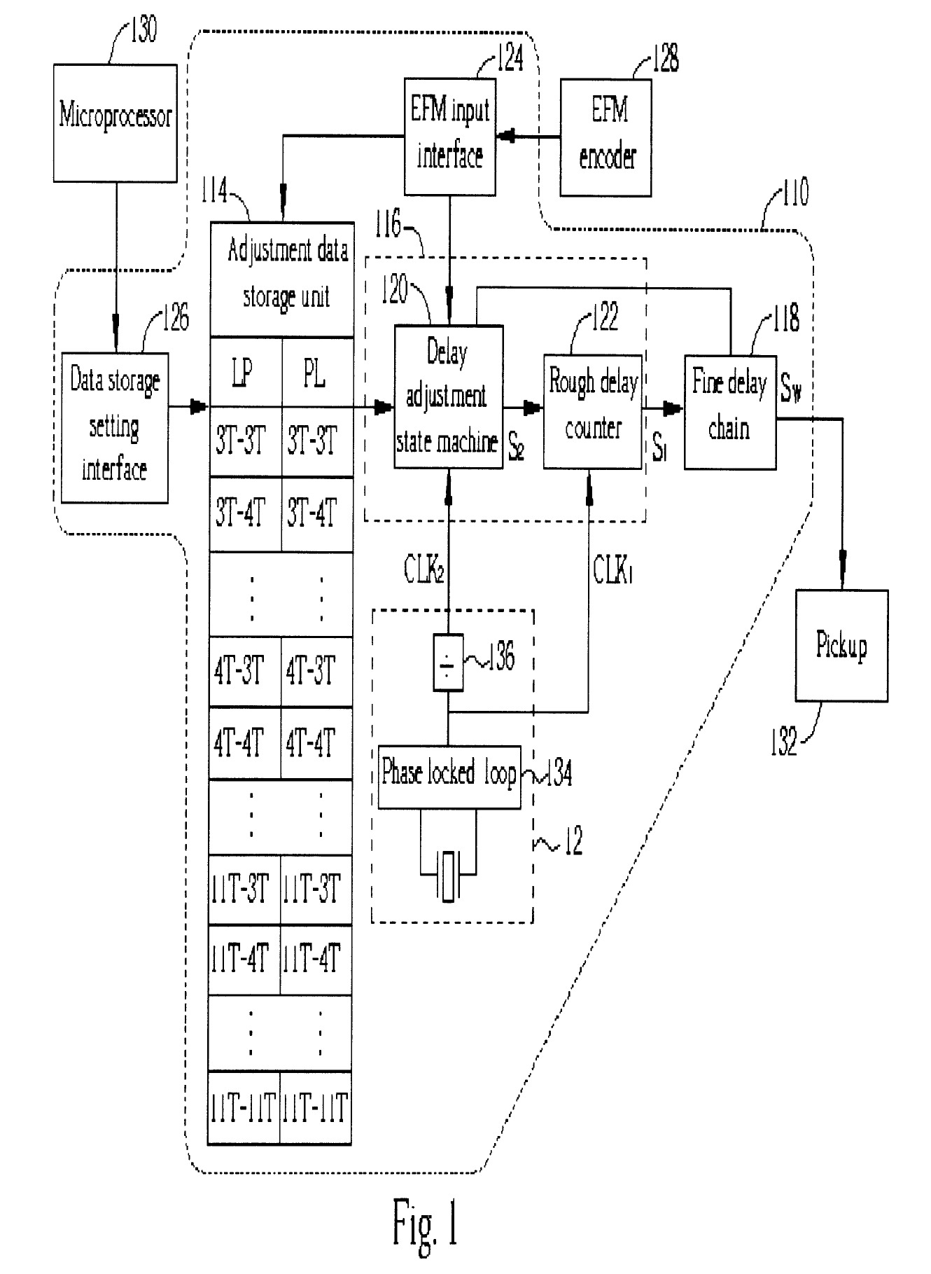

Please firstly refer to FIG. 1 showing a block diagram of a high-speed optical recording apparatus 110 according to the present invention. The high-speed optical recording apparatus 110 is installed in the optical storage device for generating a write signal according to an RLL Modulation Waveform input to the high-speed optical recording apparatus 110, so as to control a writing power of the pickup 132 in the optical storage device. As shown in FIG. 1, the high-speed optical recording apparatus 110 includes: a clock generator 112 for generating a first clock signal CLK₁, an adjustment data storage unit 114 (the above mentioned memory 114) for storing a plurality of sets of write strategy parameters, a rough delay unit 116 electrically connected to the clock generator 112 and the adjustment data storage unit 114 for receiving the first clock signal CLK₁ and a fine delay chain 118 electrically connected to the rough delay unit 116. The fine delay chain 118 has a plurality of serially connected delay cells and each delay cell is for delaying a signal by a predetermined period.

The clock generator 112 further generates a second clock signal CLK₂; and the rough delay unit 116 further comprises: a delay adjustment state machine 120 electrically connected to the clock generator 112 and the adjustment data storage unit 114 to receive the second clock signal CLK₂, and a rough delay counter 122 electrically connected to the clock generator 112 and the delay adjustment state machine 120 to receive the first clock signal CLK₁. The high-speed optical recording apparatus 110 further comprises: a channel bit(EFM; Eight-to-Fourteen Modulation for CD) input interface 124 for receiving the NRZl channel bit waveform from an encoder 128 and generating an address signal; and a data storage setting interface 126 electrically connected to the adjustment data storage unit 114, and further electrically connected to a microprocessor 130 of the optical storage device to receive the sets of write strategy parameters and storing the sets of write strategy parameters into the adjustment data storage unit 114. In addition, the fine delay chain 118 is electrically connected to the pickup 132.

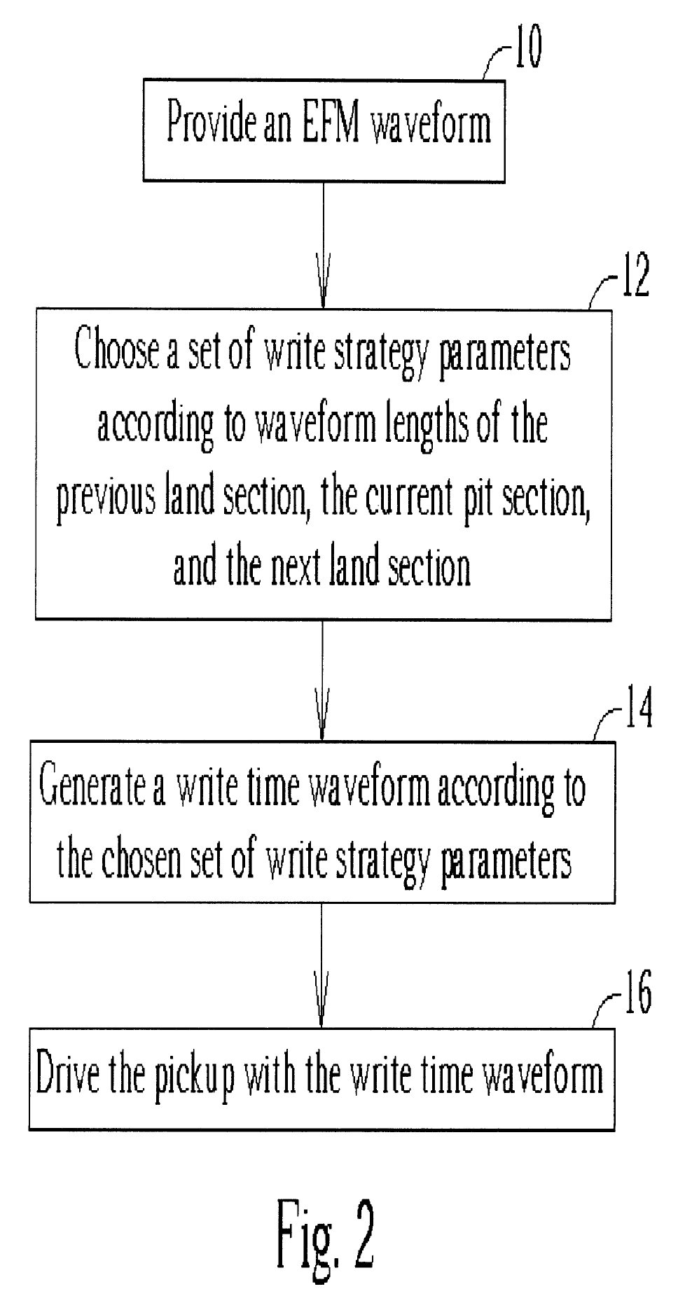

Please refer to FIG. 1 and FIG. 2. FIG. 2 is a flowchart of a method for writing data onto an optical storage medium according to the present invention. The flowchart of FIG. 2 is described as follows.

Step 10: Provide an EFM waveform through the EFM input interface 124 to the optical storage device, the EFM waveform including a previous land section, a current pit section, and a next land section;

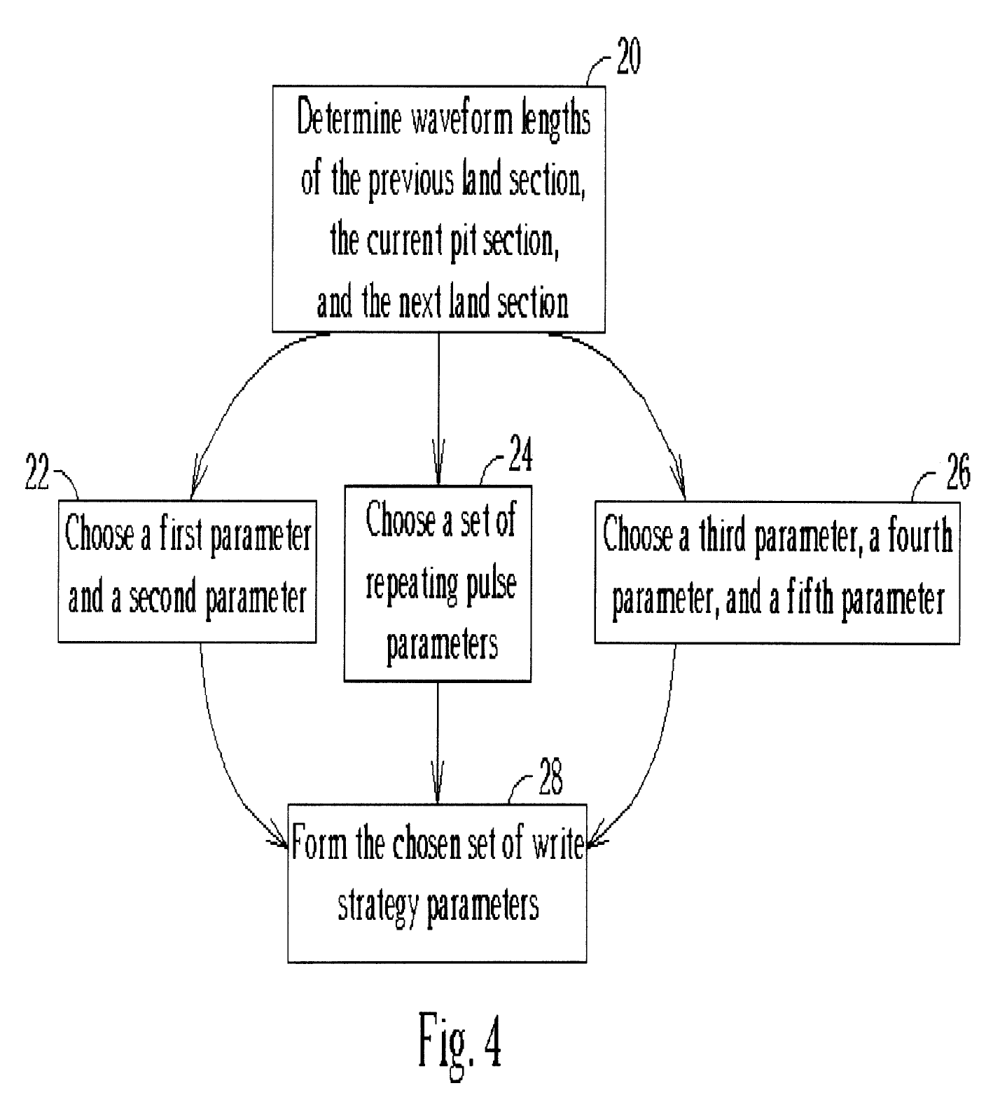

Step 12: Choose a set of write strategy parameters from the plurality of sets of write strategy parameters stored in the memory 114 with the hardware of the high-speed optical recording apparatus 110 (referring to the coming description of FIG. 4) according to waveform lengths of the previous land section, the current pit section, and the next land section;

Step 14: Generate a write time waveform with the rough delay unit 116 according to the chosen set of write strategy parameters; and

Step 16: Drive the pickup 132 with the write time waveform converted (that is, delayed) by the fine delay chain 118, so as to write data corresponding to the EFM waveform to the optical storage medium.

As previously mentioned, the EFM waveform corresponds to a plurality of pit sections representing the data and land sections on the optical storage medium. The EFM waveform has pit sections and land sections corresponding to the pit sections and the land sections on the optical storage medium. For example, a logic high of the EFM waveform represents a pit section and a logic low of the EFM waveform represents a land section. In addition, waveform lengths of each pit section and each land section are all multiples of the EFM base period, ranging from three times the base period to eleven times the base period. Each current pit section on the optical storage medium corresponds to a current pit section of the EFM waveform, a previous land section of the EFM waveform prior to the current pit section of the EFM waveform, and a next land section of the EFM waveform after the current pit section of the EFM waveform.

The major difference between the method according to the present invention and the prior art is located in Step 12. Step 12 comprises the step of choosing a set of write strategy parameters from the plurality of sets of write strategy parameters stored in the memory 114 according not only to a waveform length of a current pit section but also to waveform lengths of a previous land section and a next land section. The write strategy parameters define the pulse-widths and the intervals under different conditions of the land sections and the pit sections, so that in Step 14 a write time waveform according to the chosen set of write strategy parameters is able to be generated. As mentioned, the write time waveform is formed with a sequence of pulses switching the power of the write time waveform between an erase power state P_{E}, a bias power state P_{B}, and a write power state P_{W}. The erase power state P_{E}, the bias power state P_{B}, and the write power state P_{W} of the write time waveform are predetermined values which are independent of the EFM waveform inputted.

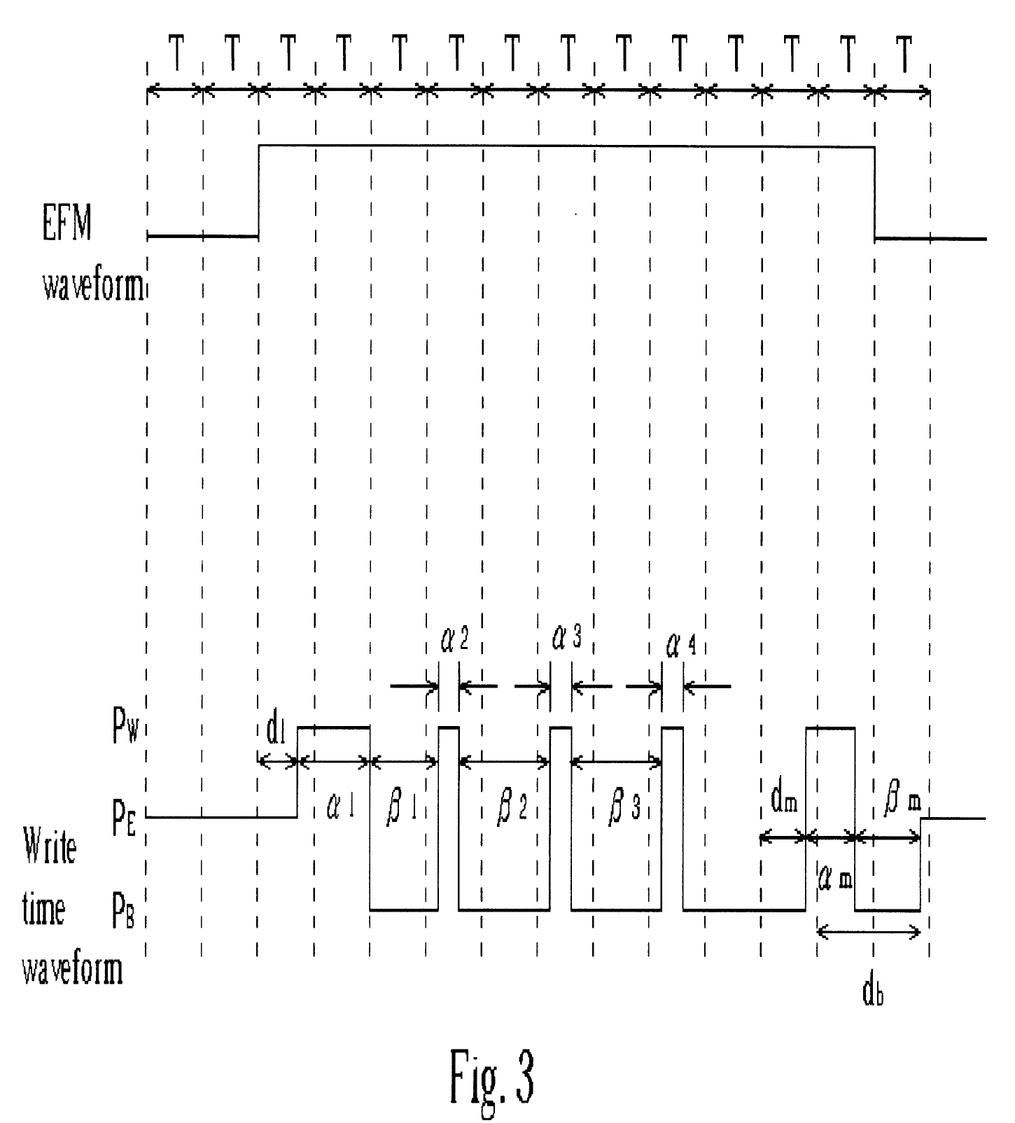

Please refer to FIG. 3 showing a waveform diagram of write strategy parameters of a 2T strategy modified according to the present invention. The method of choosing the set of write strategy parameters is described as follows. In the preferred embodiment of the present invention a method of defining the write strategy parameters according to the 2T strategy is used. That is, the length of a pulse period of the write time waveform according to the 2T strategy is equal to a length of twice the EFM base period. In FIG. 3, a distance between any two consecutive dashed vertical lines is equal to one EFM base period. An EFM waveform with a length of a current pit section which is equal to a length of eleven times the base period (11T) is shown for example. According to this, the write strategy parameters defined in the method of the present invention are shown with the write time waveform of FIG. 3 and will be described in detail as follows.

The method of the present invention defines several parameters, a first parameter d₁ representing a delay from a leading edge of the current pit section to a leading edge of a first pulse of the write time waveform. A second parameter β₁ represents a delay from a trailing edge of the first pulse of the write time waveform to a leading edge of the next pulse of the first pulse. A plurality of repeating pulse parameters α₂, α₃, α₄, . . . represents pulse lengths of all but the first pulse and the last pulse, a length between leading edges of any two consecutive pulses among all but the first pulse and the last pulse being equal to twice the length of the base period. A third parameter dₘ represents a delay from a position twice the base period before the trailing edge of the current pit section to the leading edge of the last pulse of the write time waveform. A fourth parameters αₘ represents the length of the last pulse of the write time pulse. Finally, a fifth parameter d_{b} represents a delay from a position one base period before the trailing edge of the current pit section to the position where the write time waveform switches back to the erase power state. Note that the plurality of repeating pulse parameters α₂, α₃, α₄, . . . can be equal to one another or not, depending on different embodiment choices.

Other characteristics of the write time waveform of FIG. 3 can be derived from the write strategy parameters defined above. For example, a length of the first pulse α₁ of the write time waveform is equal to a length of twice the base period subtracting the first parameter d₁ (that is, α₁=T−d₁). A delay from a trailing edge of any but the first and the last pulses to a leading edge of the next pulse is equal to a length twice the base period subtracting a length of the pulse (that is, β₂=2T−α₂, β₃=2T−α₃, . . . ). Furthermore, a delay from the trailing edge of the last pulse of the write time waveform to the point where the write time waveform switches back to the erase power state P_{E} is equal to the fifth parameter d_{b} plus a length of one base period T subtracting the third parameter dₘ subtracting the fourth parameter αₘ (that is, βₘ=d_{b}+T−dₘ−αₘ).

Please refer to FIG. 1 and FIG. 4. FIG. 4 is a flowchart of the method of choosing a set of write strategy parameters of Step 12 in FIG. 2, wherein the plurality of the write strategy parameters stored in the memory 114 include a plurality of first parameters d₁, a plurality of second parameters β₁, a plurality of sets of repeating pulse parameters α₂, α₃, α₄, . . . , a plurality of third parameters dₘ, a plurality of fourth parameters αₘ, and a plurality of fifth parameters d. The method of FIG. 4 comprises the following steps.

Step 20: Determine waveform lengths of the previous land section, the current pit section, and the next land section with the rough delay unit 116 cooperated with the EFM input interface 124 and the memory 114 according to the EFM waveform;

Step 22: Choose with the rough delay unit 116 a first parameter d₁ from the plurality of first parameters d₁ according to waveform lengths of the previous land section and/or the current pit section, and a second parameter β₁ from the plurality of second parameters β₁ according to waveform lengths of the previous land section and/or the current pit section;

Step 24: Choose a set of repeating pulse parameters α₂, α₃, α₄, . . . from the sets of repeating pulse parameters with the rough delay unit 116 according to a waveform length of the current pit section;

Step 26: Choose a third parameter dₘ from the plurality of third parameters dₘ with the rough delay unit 116 according to waveform lengths of the current pit section and the next land section, choose a fourth parameter αₘ from the plurality of fourth parameters αₘ with the rough delay unit 116 according to the waveform length of the current pit section, and choose a fifth parameter d_{b} from the plurality of fifth parameters d_{b} with the rough delay unit 116 according to the waveform lengths of the current pit section and the next land section;

Step 28: Form the chosen set of write strategy parameters with the chosen first parameter d₁, the chosen second parameter β₁, the chosen set of repeating pulse parameters α₂, α₃, α₄, . . . the chosen third parameter dₘ, the chosen fourth parameter αₘ, and the chosen fifth parameter d_{b}, the formation of the chosen set of write strategy parameters relies on the cooperation of the rough delay unit 116 and the fine delay chain 118.

Of concern, although a trailing edge of the first pulse of the write time waveform is in alignment with a position twice the base period posterior to a leading edge of the current pit section as shown in FIG. 3, this is not a limitation. In another embodiment, a trailing edge of the first pulse of the write time waveform can be in alignment with a position of a leading edge of the current pit section.

In contrast to the prior art, the present invention method for writing data onto an optical storage medium using an optical storage device can choose a corresponding set of write strategy parameters from a plurality of sets of write strategy parameters stored in a memory. The choice is made according to information of the previous land, the current pit, and the next land of an EFM waveform provided; more specifically the chosen set of write strategy parameters is determined according to not only the information of the current pit section but also that of the previous land section prior to the current pit section and the next land section after the current pit section, so that a more accurate control over the lengths of the land sections and the pit sections on a surface of the optical storage medium can be achieved. In addition, the present invention method utilizes the 2T strategy and defines the write strategy parameters in great detail, so that the solidifying time shortage problem of the 1T strategy is solved and there is higher degree of freedom to adjust the write strategy parameters to adequately eliminate jitters of the current pit sections due to internal inaccuracies of the optical storage medium.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method adapted to an optical storage device for writing data to an optical storage medium, the optical storage device having a memory and a pickup, the memory storing a plurality of sets of write strategy parameters, the method comprising:
providing an RLL modulation waveform to the optical storage device, the RLL modulation waveform including a previous land section, a current pit section, and a next land section;
choosing a set of write strategy parameters from the plurality of sets of write strategy parameters stored in the memory according to waveform lengths of the previous land section, the current pit section, and the next land section;
generating a write time waveform according to the chosen set of write strategy parameters; and
driving the pickup with the write time waveform, so as to write data corresponding to the RLL modulation waveform to the optical storage medium.

2. The method of claim 1 wherein the RLL modulation waveform has a base period, the method further comprising:
setting the write time waveform to an erase power state before the optical storage device writes data; and
setting the write time waveform to a bias power state and inserting a plurality of pulses into the write time waveform when the optical storage device writes data, and each pulse switching the write time waveform from the bias power state to a write power state.

3. The method of claim 2 wherein the write strategy parameters include a plurality of first parameters and a plurality of second parameters, each of the first parameter representing a delay from a leading edge of the current pit section to a leading edge of a first pulse of the write time waveform, each of the second parameter representing a delay from a trailing edge of the first pulse of the write time waveform to a leading edge of the next pulse of the first pulse, the method further comprising:
choosing a first parameter from the plurality of first parameters according to waveform lengths of the previous land section and/or the current pit section; and
choosing a second parameter from the plurality of second parameters according to waveform lengths of the previous land section and/or the current pit section.

4. The method of claim 3 wherein a trailing edge of the first pulse of the write time waveform is in alignment with a position of a leading edge of the current pit section or in alignment with a position twice the base period posterior to a leading edge of the current pit section.

5. The method of claim 3 wherein a length of the first pulse of the write time waveform is equal to a length of twice the base period subtracting the chosen first parameter.

6. The method of claim 2 wherein the write strategy parameters include a plurality of sets of repeating pulse parameters, each set of repeating pulse parameters having a plurality of repeating pulse parameters, the repeating pulse parameters representing pulse lengths of all but the first and the last pulses, a length between leading edges of any two consecutive pulses among all but the first and the last pulses being equal to twice the length of the base period, the method further comprising:
choosing a set of repeating pulse parameters from the sets of repeating pulse parameters according to a waveform length of the current pit section.

7. The method of claim 6 wherein the repeating pulse parameters in the same set of repeating pulse parameters are equal to one another.

8. The method of claim 6 wherein the repeating pulse parameters in the same set of repeating pulse parameters are not necessarily equal to one another.

9. The method of claim 2 wherein the write strategy parameters include a plurality of third parameters, a plurality of fourth parameters, and a plurality of fifth parameters, each third parameter representing a delay from a position twice the base period prior to a trailing edge of the current pit section to a leading edge of a last pulse of the write time waveform, each fourth parameter representing a length of the last pulse of the write time pulse, each fifth parameter representing a delay from a position one base period prior to the trailing edge of the current pit section to a position the write time waveform switching back to the erase power state, the method further comprising:
choosing a third parameter from the plurality of third parameters according to waveform lengths of the current pit section and the next land section;
choosing a fourth parameter from the plurality of fourth parameters according to the waveform length of the current pit section; and
choosing a fifth parameter from the plurality of fifth parameters according to the waveform lengths of the current pit section and the next land section.

10. The method of claim 9 wherein a delay from a trailing edge of the last pulse of the write time waveform to a position the write time waveform switching back to the erase power state is equal to the chosen fifth parameter plus a length of one base period subtracting the chosen third parameter subtracting the chosen fourth parameter.

11. The method of claim 2 wherein a delay from a trailing edge of any but the first and the last pulses in the write time waveform to a leading edge of the next pulse is equal to a length twice the base period subtracting a length of the pulse.

12. The method of claim 2 wherein waveform lengths of the previous land section, the current pit section, and the next land section are all multiples of the base period, ranging from three times the base period to eleven times the base period.

13. The method of claim 2 wherein levels of the erase power state, the bias power state, and the write power state are predetermined values, and do not vary with different RLL modulation waveforms.

14. The method of claim 1 being adapted to a CD burner.

15. The method of claim 14 being capable of writing data onto a CD-RW.

16. The method of claim 1 being adapted to a DVD burner.

17. The method of claim 16 being capable of writing data onto a DVD-R.

18. The method of claim 16 being capable of writing data onto a DVD-RW.

19. The method of claim 1 wherein the RLL modulation waveform is an eight-to-fourteen modulation waveform.
